(19) United States
(12) Patent Application Publication
(10) Pub. No.: US 2007/0274490 A1
(43) Pub. Date: Nov. 29, 2007

(54) METHOD AND DEVICE FOR PROCESSING SESSION

(75) Inventors: Lixin Hu, Shenzhen (CN); Yong Zhu, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/765,701

(22) Filed: Jun. 20, 2007

Related U.S. Application Data
(63) Continuation of application No. PCT/CN05/01950, filed on Nov. 18, 2005.

(30) Foreign Application Priority Data
Dec. 22, 2004 (CN) 200410101759.5

(51) Int. Cl. H04M 3/42

(52) U.S. Cl. 379/201.01

(57) ABSTRACT

The embodiments of the present invention provide a method for processing session, which includes: obtaining a session request for requesting a session between a calling user and a called user, wherein the session request contains first charging information and is from a first communication unit; obtaining second charging information from a second communication unit; generating a result according to the first charging information and the second charging information; processing the session according to the result. The embodiments of the present invention also provide a device for processing session. In the embodiments of the present invention, a user may conveniently control a rate, duration and fee of a session.

This application is a continuation of International Patent Application No. PCT/CN2005/001950, filed Nov. 18, 2005, which claims priority to Chinese Patent Application No. 200410101759.5, filed Dec. 22, 2004, all of which are hereby incorporated by reference.

### FIELD OF THE TECHNOLOGY

The present invention relates to the field of charging in a communication system, and particularly to a method and a device for processing session.

### BACKGROUND OF THE INVENTION

Charging processing is very important in telecommunication services. It provides a telecommunication operator with charging information so that the operator may carry out relevant account processing. Moreover, by providing the charging information to a relevant third-party service provider, the account settlement between the third-party service provider and the telecommunication operator may be done when two operators are concerned.

The present fixed phone services are charged mainly based on a called number, for example 800**** for free call, 0139**** for toll call, 878**** for local call, and 97**** for charged information call. A user may learn a relevant rate in advance, reckon a call by time, and figure out a fee according to the rate so as to control the call duration.

In a Next Generation Network (NGN), however, there are a variety of communication modes, such as message, voice, and multimedia, so it is impossible to charge according to the called number. Along with the rapid updating of services, it is difficult for a user to timely learn the rate of the new one. Furthermore, a plurality of services is provided by third-party service providers. So when a user uses a service, multiple operators and service providers may be involved, and they may all charge the user. It is difficult for the user to learn the fee each operator collects. Therefore, the user may not know how a service is charged and what a bill he will face. Even when he finishes using the service, he is still ignorant of how the bill will be like until receiving the bill from the telecommunication operator at the end of a month.

That is, in the NGN, it is even more difficult for the user to predict how much he has to pay for a service, so he can not control call duration beforehand according to the fee and decide whether he will use the service.

### SUMMARY OF THE INVENTION

The embodiments of the present invention provide a method and a device for processing session to enable a user to conveniently control the rate, duration or fee of a session.

A method for processing session includes:

obtaining a session request for requesting a session between a calling user and a called user, wherein the session request contains first charging information and is from a first communication unit;

obtaining second charging information from a second communication unit;

generating a result according to the first charging information and the second charging information;

processing the session according to the result.

A device for processing session includes:

a session message receiving/transmitting unit, configured to receive a session request for requesting a session between a calling user and a called user and send second charging information, wherein the session request includes first charging information;

a session processing unit, configured to process the session according to a result generated based on the first charging information received from the session message receiving/transmitting unit and the second charging information.

A device for processing session includes:

a first obtaining unit, configured to obtain a session request for requesting a session between a calling user and a called user, wherein the session request contains first charging information and is from a first communication unit;

a second obtaining unit, configured to obtain second charging information from a second communication unit;

a processing unit, configured to generate a result according to the first charging information and the second charging information and process the session according to the result.

As can be seen from the above technical scheme, a user may set a desired rate, fee, or call duration, thereby implementing the management of services.

A transfer of charging information between a user and an operator makes it possible to transfer the charging information between operators, so as to enable the operator to provide the user with charging information according to charging information provided by other operators. In addition, the fee status may be gotten in real time due to the combination of the charging and a specific session. For example, a user may get charging information before, during and after a session, and may refuse the session before initiating the session, or terminate the session during the session so as to save fees.

With a specific charging rule, both users and operators may do a charge calculation to check up the account. Because of setting a ceiling through repayment, and setting a desired fee or duration, the user may better control the call fee or duration.

### BRIEF DESCRIPTION OF THE DRAWINGS

FIG. 1 is a structure diagram of an INVITE message according to embodiments of the present invention.

FIG. 2 is a simplified flowchart illustrating the session processing of charging a calling user according to an embodiment of the present invention.

FIG. 3 is a simplified flowchart illustrating the session processing of charging a called user according to an embodiment of the present invention.

FIG. 4 is a simplified flowchart illustrating the session processing of charging for an additional rate service according to an embodiment of the present invention.

FIG. 5 is a simplified schematic diagram illustrating a device for processing session according to an embodiment of the present invention.

### DETAILED DESCRIPTION OF THE INVENTION

In an NGN, it is an SIP that is frequently used for communications due to its flexibility. The SIP, defined by the Internet Engineering Tasking Force (IETF), is a session control protocol with simplicity and rich expansibility, and is a basic protocol of the NGN. Embodiments of the present invention are described based on, but not limited to, the SIP.

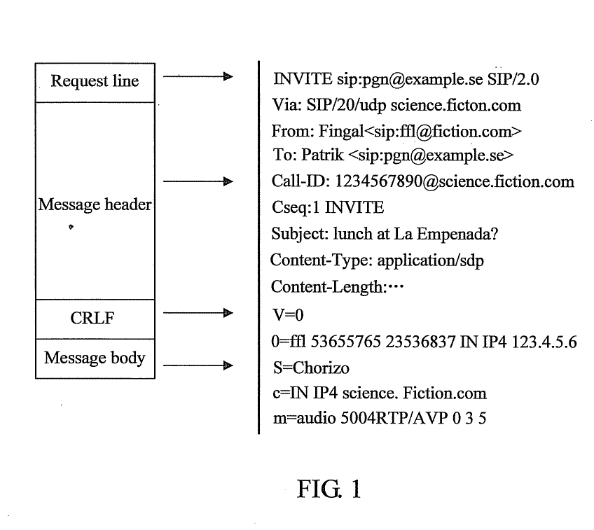

The SIP, not depending on underlying layer protocols, is a text-based application layer control protocol, and is used to establish, modify and terminate two-party or multi-party multimedia sessions in an Internet Protocol (IP) network. The SIP borrows ideas from the Hyper Text Transfer Protocol (HTTP), Simple Mail Transfer Protocol (SMTP) and the like, supports such functions as agent, re-determination of direction, registering and locating users, etc., and supports user mobility. When cooperating with such protocols as Real time Transport Protocol/Real time Control Protocol (RTP/RTCP), Service Description Protocol (SDP), Real Time Streaming Protocol (RTSP) and Domain Name Service (DNS), the SIP may realize such services as voice, video, data, mail, real time communication, chat, etc. An SIP message is based on the text mode, and typically includes a request line, a message header, a Carriage Return, Line Feed (CRLF), and a message body. For example, a structure of a request message (INVITE) based on the SIP is shown in FIG. 1.

In the SIP, information related to charging function has not been defined, and the account settlement mode mentioned in “Background of the invention” is still used at present when the communication is based on the SIP, so similar problems to that mentioned in “Background of the invention” still exist. The charging method according to this invention is described below in detail.

For realizing the charging method of this invention, the SIP is improved, namely a charging information byte, i.e., Charge (called Session Charge Protocol) is added. The charging information includes: fee information (Fee), volume information (Volume) and rate information (Rate). For example, a Charge may include zero or one Fee, zero or multiple Volume, and zero or multiple Rates. In the charging information, the fee, volume and rate are associated. The fee may be figured out according to the volume and rate, and the simplest case is volume*rate=fee. In the case of multiple rates and volume, their products are summated.

In detail, the Fee, Volume and Rate included in the Charge mentioned above may be finalized below.

Merely by way of an example, the Fee includes two parts, Currency meaning currency type and Amount meaning the amount of money, wherein the Currency is expressed by the letter format specified in International Standards Organization (ISO) 4217 and the Amount is expressed by a figure. For example, for RMB 1 yuan 1 jiao 9 fen, “CNY” for expressing RMB is filled in the Currency part and “1.19” in the Amount part. A positive fee value in a message sent may mean that a Charge message sender server pays the receiver server; and a negative one means the Charge message sender server charging the receiver server. The servers mean servers provided by different operators.

Merely by way of an example, the Volume includes two parts: UnitID meaning a unit used in charging and Amount meaning volume used. The UnitID is represented by a figure: 0-Undefined, 1-the number of times, 2-byte, 3-second, which may be extended to represent other units. For example, for the volume of 100 bytes, “2” is filled in the UnitID part, and “100” in the Amount part.

Merely by way of an example, the Rate includes four items of information: Currency meaning currency type, Amount meaning the amount of money, UnitID meaning a unit used in charging and Amount meaning volume used. In the case of multiple Rates, charging is performed by the corresponding Rates in turn according to the Amount meaning volume used (such as time), and the last Rate is taken as a subsequent rate for the charging. For example, that the Amounts are 180, 120 and 60 respectively corresponding to Rate1, Rate2 and Rate3 means that the rate is Rate1 for the first 180 seconds, Rate2 for the subsequent 120 seconds, Rate3 for the further subsequent 60 seconds, and keeps Rate3 afterwards.

When carried in the SIP, the Charge may be contained in a message header through adding a header field, or in an SIP message body, as shown in FIG. 1. An INVITE message containing charging information is shown below, in which a part written in italics is the added Charge header field, and the content of charging information is filled in the part. In the INVITE message, the contained charging information means that the fee is RMB 0.32 yuan, the volume is 270 seconds, the rate is 0.20 yuan for the first 3 minutes and 0.06 fen per minute afterwards.

INVITE sip:bob@biloxi.com SIP/2.0

Via: SIP/2.0/UDPpc33.atlanta.com;branch=z9hG4bK776asdhds

Max-Forwards: 70

To: Bob<sip:bob@biloxi.com>

From: Alice<sip:alice@atlanta.com>;tag=1928301774

Call-ID: a84b4c76e66710@pc33.atlanta.com

CSeq: 314159 INVITE

Contact: <sip:alice@pc33.atlanta.com>

Charge: Fee; Currency=‘CNY’, Amount=0.32

Charge: Volume; Unitid=1, Amount=270

Charge: Rate; Currency=‘CNY’, Price=0.20, Unitid=1, Amount=180

Charge: Rate; Currency=‘CNY’, Price=0.06, Unitid=1, Amount=60

Content-Type: application/sdp

Content-Length: 142

Charging information also may be carried through adding three header fields, i.e., Fee, Volume and Rate, instead of the above Charge header field, and the three header fields is shown below:

Fee: 0.32; Currency=‘CNY’

Volume: 270; Unitid=1

Rate: 0.20; Currency=‘CNY’, Unitid=1, Amount=180

Rate: 0.06; Currency=‘CNY’, Unitid=1, Amount=60

Meanings of charging information carried in the SIP are described as below.

INVITE is used to carry charging information when a call is requested, and means that an SIP client is willing to pay. During the call, the charging information may also be resent via an INVITE message.

200 OK corresponds to 200 OK of INVITE. That charging information is contained in a response message means that an SIP server has accepted the request of the SIP client, and carried the charging information in the response message. The rate and amount in the charging information are less than those in the INVITE message sent from the SIP client.

402 Payment Required is used to contain charging information in a payment request, and means that the SIP server does not accept the charging information in the INVITE message sent from the SIP client, and returns the charging information of the SIP server with a rate higher than that in the charging information contained in the INVITE message sent from the SIP client. The SIP client may resend an INVITE message after prompting the user.

BYE is used to carry actual charging information for this session after a call is over.

200 OK corresponds to 200 OK of BYE, and is used to carry the actual charging information of this session.

Charging information may be contained in other extended messages of the SIP, e.g., an extended SUBSCRIBE message in the SIMPLE protocol (SIP for Instant Messaging and Presence Leveraging Extensions), and the illustration is no longer made.

Through the Charge, the charging information may be transferred between the user equipment and the server, so as to realize the control of the user on a call fee and the display of fee information to the user, and a description in detail is given below.

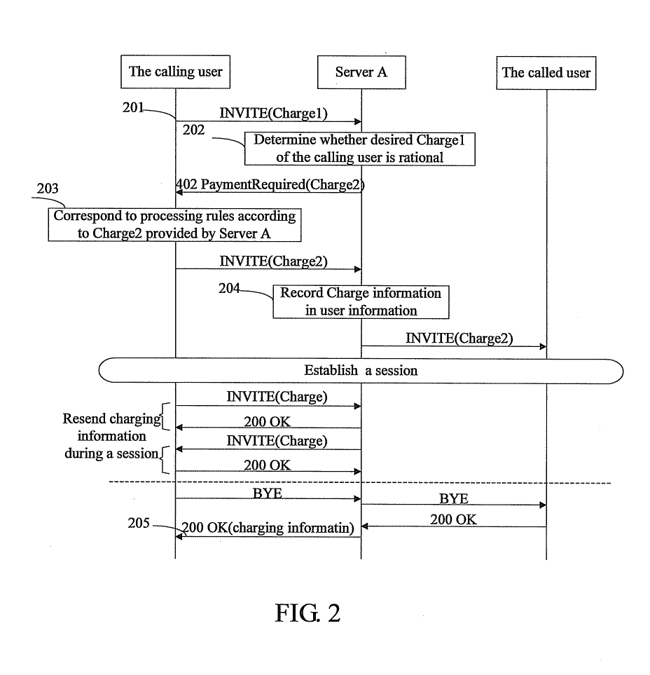

A session processing of charging a calling user according to desired charging information of the calling user is described through an example of the calling user calling the called user, referring to FIG. 2.

Step 201: the calling user equipment initiates a call, and sends an INVITE message to Server A. A charging information byte, i.e., Charge, is contained in the INVITE message to represent desired charging information of the calling user. In the call, the meanings of parameters included in the Charge are as follows: the Fee represents a fee the calling user is willing to pay; the Volume, desired maximum volume of the calling user for this call; the Rate, a desired rate of the calling user.

In the Charge, one or two of the Fee, Volume and Rate also may be included. For example, only the Fee being included represents a total fee that the calling user is willing to pay for this call and accepting the rate of the operator; only the Volume represents maximum volume that the calling user is willing to take for this call (such as duration) and accepting the rate and fee of the operator; only the Rate represents a desired rate of the calling user for this call.

The calling user equipment may prestore a charging rule table as shown in Table 1. When initiating an INVITE message, the calling user equipment reads the stored charging rule table, matches the charging rules to specific rules, reads charging information corresponding to the specific rules, and fills the read charging information in the INVITE message. If the calling user does not set charging rules or does not match the charging rules to the specific rules, he fills an empty Charge header field in the INVITE message instead of a specific value, e.g., Charge: Fee, to represent that the calling user is willing to accept the charging rules provided by the server.

TABLE 1

| Rule | Fee | Volume | Rate |
|---|---|---|---|
| Calling the called user | 2 yuan | 1 minute | 1 yuan/minute |
| tom@jack.com | | | |
| The superior operator is abc | 100 yuan | 1 minute | 100 yuan/minute |
| (abc is the operator trusted | | | |
| by the user) | | | |
| Other cases | 0.1 yuan | 1 minute | 0.1 yuan/minute |

Certainly, the calling user equipment may provide the calling user with a dialog box to input charging information when initiating a call.

As shown below, an INVITE message is generated when the user Alice calls her superior operator server in Atlanta so as to call the called user bob@biloxi.com. The call meets the rule “other cases” in above Table 1, which means that the calling user is only willing to pay RMB 0.1 yuan, call for 1 minute, and only accept a rate less than RMB 0.1/minute. The INVITE message is as:

INVITE sip:bob@biloxi.com SIP/2.0

Charge: Fee; Currency=‘CNY’, Amount=0.1

Charge: Volume; Unitid=1, Amount=60

Charge: Rate; Currency=‘CNY’, Price=0.10, Unitid=1, Amount=60

Certainly, if the calling user equipment asks the server to provide charging information when initiating a call, in Step 201, the message sent from the calling user equipment may not include the desired charging information of the calling user but a field for asking the server to return the charging rules information to the calling user equipment. For example, 402 Payment Required may be added respectively in a Supported header field of INVITE message and a Require header field. An INVITE message with the request field is shown below.

INVITE sip:bob@biloxi.com SIP/2.0

Supported: 402 Payment Required

Require: 402 Payment Required

Step 202: Server A receives the INVITE message, reads the charging information of the calling user equipment, and determines whether the charging information is reasonable; if it is, the process proceeds to Step 204, or else, Server A returns to the calling user equipment a response message with the charging rules of Operator 1 recorded in Server A.

Server A determines whether the parameters of the charging information in the INVITE message (i.e., Fee, Volume and Rate) are reasonable. When only a parameter exists in the charging information, the comparison is made only for the parameter; when two or more parameters exist, comparison needs to be made for all parameters.

For example, when only the Rate exists in the INVITE message exists, if the fee figured out in any case of the volume according to the desired rate of the calling user is not less than that according to the rate of the operator, the rate is considered reasonable, e.g., desired 0.12 yuan/minute of the calling user and 0.1 yuan/minute provided by the operator; otherwise, the rate is unreasonable, e.g., if the calling user desires a rate of 0.12 yuan/minute and requests call duration of two minutes, while the operator provides 0.3 yuan/3 minute, the fee will be 0.24 yuan according to the rate of the calling user, and 0.3 yuan according to the rate of the operator, so the rate requested by the calling user is unreasonable.

For another example, when only the Fee exists, if the fee is more than a minimum call fee requested by the operator, e.g., in the case of 0.3 yuan/3 minute, the minimum call fee is 0.3 yuan, the fee is reasonable; otherwise, the fee is unreasonable.

Eventually, for example, when at least two of Rate, Fee and Volume exist in the INVITE message, the rate, fee and volume all may be figured out, in this case, not only the rate but also the fee has to be compared. For example, after the desired fee of the calling user is considered reasonable, the rate is further determined whether reasonable or not. Unless both the fee and the rate are reasonable, this charging rule is not considered reasonable. Certainly, if the calling user is a prepayment user, the operator equipment still has to determine whether the fee of the calling user exceeds a credit line, and the charging information is reasonable only if the fee is within the credit line.

If the server determines that the charging information is unreasonable, the returned response message also contains the charging rule information whose parameters means: the Rate represents a rate requested by the operator; the Fee and Volume represent a desired fee and volume of the calling user (according to the first user request, if there is no volume in the first user request or the volume is less than the minimum volume accepted by the operator, a minimum charging unit may be responded to the calling user equipment). The shown below is a response message returned from Server A, which includes a charging rule set by Operator 1: a rate of 0.20 yuan for the first three minutes and 0.06 fen per minutes for later, minimum call duration of 180 seconds, and a minimum fee of 0.20 yuan.

SIP/2.0 402 Bad charge

Charge: Fee; Currency=‘CNY’, Amount=0.20

Charge: Volume; Unitid=1, Amount=180

Charge: Rate; Currency=‘CNY’, Price=0.20, Unitid=1, Amount=180

Charge: Rate; Currency=‘CNY’, Price=0.06, Unitid=1, Amount=60

Step 203: the calling user equipment receives the response message from Server A, reads the charging information provided by the operator, and matches the charging information to preset processing rules to carry out a corresponding processing.

The preset processing rules may be shown as Table 2 below. The calling user equipment reads the fee, volume and rate from the response message, matches them with the processing rules in FIG. 2, and carries out a corresponding processing.

TABLE 2

| Rule | Processing rule |
|---|---|
| Fee is more than 10 yuan | Reject directly without reminding |
| Fee is less than 0.1 yuan | Accept directly without user |
| | confirmation |
| Rate is higher than 0.1 yuan/minute | Accept with user confirmation |
| Volume is less than 1 minute | not accept |

The rules may be set according to other conditions, e.g., a role in a session (the called or the calling) and an ID of the other party (certified through an ID, such as a friend list, password certification).

In addition, charging information or prompting information of the processing rules may be provided to the calling user to prompt simple information in terms of word, graphic and voice modes. For example, if the fee exceeds the one in the rules set by the calling user, user confirmation is needed. In this case, graphics flashes on the calling user equipment with a sound and word information related to the calling user.

In the example, after receiving the message of Server A of the Operator 1, if the rule of “Rate is higher than 0.1 yuan/minute” is met, the calling user equipment prompts the calling user. After the calling user confirms to accept, the calling user equipment reinitiates an INVITE message. The charging information forwarded by Server A through a response message is filled in the INVITE message to represent charging information of Operator 1. The INVITE message is shown below:

INVITE sip:bob@biloxi.com SIP/2.0

Charge: Fee; Currency=‘CNY’, Amount=0.20

Charge: Volume; Unitid=1, Amount=180

Charge: Rate; Currency=‘CNY’, Price=0.20, Unitid=1, Amount=180

Charge: Rate; Currency=‘CNY’, Price=0.06, Unitid=1, Amount=60

Certainly, after the calling user confirms to accept, when the calling user equipment reinitiates an INVITE message, an empty Charge header field, such as Charge: Fee, may be filled in the SIP as shown in Step 201 to express that the calling user accepts the charging rules provided by the server.

Step 204: in this way, after receiving the INVITE message and determining as a reasonable charging rule, the Server A continues processing the call request, establishes a session between the calling user equipment and the called user equipment, and records the Fee and Volume in the Charge provided by the calling user.

During the session, the charging information will be resent in the following cases:

1) the volume or fee for the session will exceed the recorded desired volume or fee of the calling user;

2) the fee has changed;

3) other information related to the session has changed, for example, the Quality of Service (QoS) is reduced, but the fee is unchanged, in this case, the calling user needs to reconfirm.

Both a user equipment and a server may resend to the other party charging information, which is determined whether reasonable or not by the other party. For example, when the rate, fee and volume exceed those set for the current session, the user is prompted to resend the charging information or the session is cut off automatically. Thus, the user may preset his call duration or fee before initiating a session so as to control the session.

For example, if the call duration exceeds three minutes, the calling user equipment prompts the calling user; after the calling user confirms, the calling user equipment reinitiates an INVITE message. The process also may be performed according to the rules set by the user: when the rate is unchanged, user confirmation is not needed, and an INVITE message is reinitiated automatically; more volume is filled in the Charge, e.g., another 10 minutes prolonged, so the “13 minutes” is filled in the Volume (3 minutes plus 10 minutes); the fee is increased accordingly, and “0.80 yuan” filled in the Fee. The INVITE message is shown below:

INVITE sip:bob@biloxi.com SIP/2.0

Charge: Fee; Currency=‘CNY’, Amount=0.80

Charge: Volume; Unitid=1, Amount=780

Charge: Rate; Currency=‘CNY’, Price=0.20, Unitid=1, Amount=180

Charge: Rate; Currency=‘CNY’, Price=0.06, Unitid=1, Amount=60

After receiving the INVITE message, if the charging information is considered reasonable, Server A of Operator 1 will accept the request of the calling user, do not cut off the session and respond to the calling user equipment with 200 OK.

Step 205: after the session ends, the calling user equipment and Server A may calculate the fee according to the volume and rate and record it in a storage unit, in this case, the volume represents the actual volume already used up for the session, the fee represents the actual fee for the session, and the rate means the rate of the session. Server A sends the fee information of the session to the calling user equipment (e.g., contained in 200 OK), the calling user equipment prompts the calling user with charging information, compares the charging information with that of the calling user equipment, and reserves the fee after a confirmation.

Only the fee processing between the calling user equipment and the server is described above. For two or more operators are involved in a session, Server A still has to modify and send the content of fee, and servers of other operators receive the charging information and determine whether it is reasonable; only when all servers consider the fee reasonable, the session between the calling user equipment and the called user equipment may be established.

For example, the calling user calls the called user, and the charging information sent from the calling user equipment to the Server A of Operator 1 includes: 0.2 yuan/minute, Operator 1 charging 0.06 yuan per minute and taken a 10% deduction from the income of Operator 2. In this way, Server A, after receiving the charging information of the calling user, figures out the maximum fee that Operator 2 may charge is 0.127 yuan/minute, i.e., (0.2−0.06)/110%=0.127. In the message sent from Server A to Server B of Operator 2, “0.127 yuan/minute” is filled in the Rate, and the fee is also processed appropriately.

The server of Operator 2, after receiving the charging information, makes a calculation and comparison according to the charging rules set by itself, with reference to Step 202, to decide whether the charging information is reasonable. Operator 2 may return charging information to Operator 1 through the charging information, Operator 1 then makes a corresponding calculation and returns charging information figured out to the calling user. For example, the charging rate returned by Operator 2 is 0.1 yuan/minute, the charging rate returned by Operator 1 is 0.17 yuan/minute, and 0.1+0.1 10%+0.06=0.17.

Moreover, if multiple operators are concerned, the session also may be initiated by an operator server instead of a user equipment, for example, operator server initiatively initiates a session to provide services to a user.

As can be seen, during a charging, a user may send information such as call duration, fee information, etc., and a server controls the call duration and total fee according to the information sent by the user. In addition, it may be displayed to the user how each operator charges.

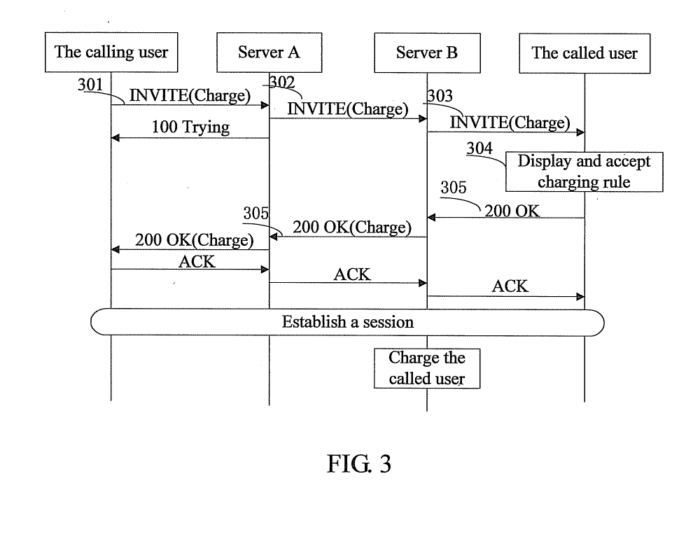

According to another example with the called user charged, this invention is further described below in detail with reference to FIG. 3, wherein there is an account of the called user recorded in Server B of Operator 2. The following steps are included:

Step 301: the calling user equipment calls Server A of Operator 1, and the carried Charge includes: the rate is 0 yuan/minute, which means that the calling user asks to get a free call.

Step 302: Server A asks to charge 0.06 yuan/minute, so it processes the charging information, namely, changes the rate to −0.06 yuan/minute, and sends the charging information to Server B of Operator 2. The negative sign means that Operator 1 charges Operator 2.

Step 303: Server B still asks to charge 0.1 yuan/minute, so it changes the rate to −0.16 yuan/minute, which means charging the user 0.16 yuan/minute, and forwards the session request containing the charging information to the called user.

Step 304: the called user equipment displays the charging information: the called user needs to pay −0.16 fen/minute. After the charging information is confirmed by the called user, or automatically confirmed by the called user equipment according to rules preset by the called user (may be shown as Table 2 above), the called user equipment sends a response message containing −0.16 fen/minute to Server B to express an agreement on paying and accepting the rate. The volume, i.e., call duration, or the desired fee of the called user is also contained in the Charge of the response message and sent to Server B together.

Step 305: Server B responds to Server A, and Server A considers the session request of the calling user reasonable and may establish the session between the calling user and the called user.

Meanwhile, Server B processes the charging according to the corresponding charging rules, makes a fee deduction from a recorded account of the called user, figures out the fee that the Operator 1 shall share, and performs the account settlement between operators.

In addition, when the call duration or the fee deducted by Server B is up to that in the response message from the called user equipment, the called user is prompted to resend charging information to continue session or terminate the current session.

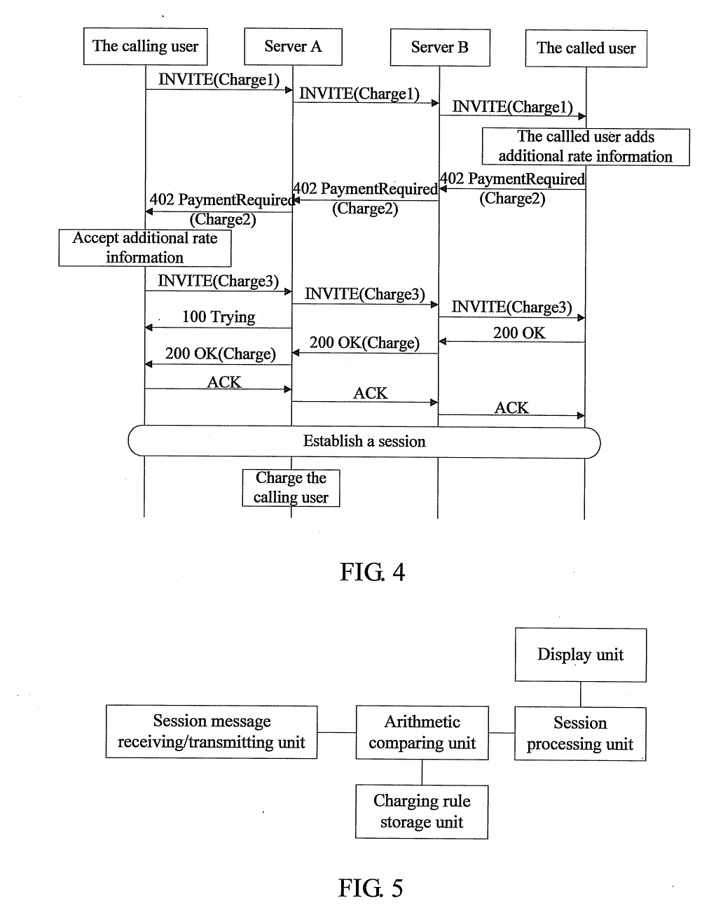

A session processing of charging for an additional rate service is shown in FIG. 4. The additional rate service means a session in which the calling user needs to pay the called user. For example, the called user equipment is used for hot-wire, consultation, order programme, etc. In this embodiment, the rate may be contained in the message responded by the called user equipment (may be a Server C provided by a third operator). Operator 2 and Operator 1 summate the rates, the calling user equipment prompts the rates to the calling user, and sends the charging information about the rate until the calling user confirms. When Operator 1, Operator 2 and the called user all consider the charging reasonable, the session may be processed.

Correspondingly, as shown in FIG. 5, a device for processing session is also provided, which may be a user equipment or a server. The device includes: a session receiving/transmitting unit, for receiving and transmitting session information; a charging rule storage unit, for storing charging rules; an arithmetic comparing unit connected with the session receiving/transmitting unit and the charging rule storage unit, for reading and comparing the received charging information from the session receiving/transmitting unit and the charging rule storage unit; and a session processing unit connected with the arithmetic comparing unit, for processing session according to the received comparing results from the arithmetic comparing unit. A display unit is also included which connects with the session processing unit for displaying the charging information or session processing information to the user.

As can be seen from the embodiments, the user may conveniently control the fee, call duration, or rate of a session according to input information (such as a fee and volume), and each server may perform the fee processing respectively according to the charging information transferred between servers of various operators.

The user equipment and the server are differentiated above for better description. In the SIP, when the user equipment and the server communicate, the SIP operator server may serve as a client to initiate a call to another server, just as the user equipment.

The above descriptions are all exemplified by communications based on SIP. As shown above, charging information may also be carried in terms of an Extensible Mark-up Language (XML) format. Although all examples are based on the SIP, it is not difficult to understand that the present invention may be used in other network protocols which are not limited to the SIP protocol or SIP extended protocols, for example, this invention may be applied in a Hyper Text Transfer Protocol (HTTP) to access Web, or in a Video On Demand (VOD).

It should be appreciated that the foregoing is only preferred embodiments of the invention and is not for use in limiting the invention. Any modification, equivalent substitution, and improvement without departing from the spirit and principle of this invention should be covered in the protection scope of the invention.

What is claimed is:

1. A method for processing session, comprising:
obtaining a session request for requesting a session between a calling user and a called user, wherein the session request contains first charging information and is from a first communication unit;
obtaining second charging information from a second communication unit;
generating a result according to the first charging information and the second charging information;
processing the session according to the result.

2. The method of claim 1, wherein said generating a result according to the first charging information and the second charging information comprises:
generating a first result while determining the first charging information is acceptable charging information applicable to the session according to the second charging information.

3. The method of claim 1, wherein said generating a result according to the first charging information and the second charging information comprises:
generating a second result while determining the first charging information is unacceptable charging information not applicable to the session according to the second charging information.

4. The method of claim 2, wherein said processing the session according to the result comprises:
putting through the session according to the first result.

5. The method of claim 3, wherein said processing the session according to the result comprises:
sending the second charging information to the first communication unit according to the second result;
receiving another information sent by the first communication unit;
putting through the session while determining, according to the second charging information, that said another charging information is acceptable charging information applicable to the session according to the second charging information.

6. The method of claim 4, wherein the first charging information comprises a desired rate, the method further comprising:
after putting through the session, terminating the session or asking the first communication unit to resend another charging information when a rate of the session changes.

7. The method of claim 4, wherein the first charging information comprises a desired fee or desired volume;
the method further comprises:
after putting through the session, calculating a fee or volume of the session; if the fee or volume of the session reaches the desired fee or the desired volume, terminating the session or asking the first communication unit to resend another charging information.

8. The method of claim 5, wherein said another charging information comprises a desired rate, the method further comprising:
after putting through the session, terminating the session or asking the first communication unit to resend a third charging information when a rate of the session changes.

9. The method of claim 5, wherein said another charging information comprises a desired fee or desired volume, the method further comprising:
after putting through the session, calculating a fee or volume of the session; if the fee or volume of the session reaches the desired fee or the desired volume, terminating the session or asking the first communication unit to resend a third charging information.

10. The method of claim 3, wherein the first charging information comprises at least one of a desired rate, a desired fee and desired volume;
the first charging information being unacceptable charging information not applicable to the session comprises at least one of:
the desired rate being lower than a minimum rate in the second charging information stored in the second communication unit;
the desired volume being less than minimum volume in the second charging information stored in the second communication unit; and
the desired fee being less than a minimum fee in the second charging information stored in the second communication unit.

11. The method of claim 3, wherein the first charging information being unacceptable charging information not applicable to the session further comprises:
if the first communication unit is a prepayment user, a balance of prepayment account of the first communication unit exceeding a credit line.

12. The method of claim 1, wherein the first communication unit stores charging rules corresponding to different sessions; and
said obtaining the session request comprises:
obtaining the session request with the first charging information from the first communication unit after the first communication unit reads a charging rule corresponding to the session and generates the first charging information according to the charging rule.

13. The method of claim 12, wherein the charging rules corresponding to different sessions comprise one of:
charging rules corresponding to different called users and charging rules corresponding to different second communication units.

14. The method of claim 5, wherein the first communication unit sending another charging information comprises one of:
determining, by the first communication unit, to send said another charging information according to a processing rule which corresponds to the second charging information and is stored in the first communication unit; and
prompting the user, and sending said another charging information applicable to the session after obtaining a confirmation from the user.

15. The method of claim 5, further comprising:
taking, by the first communication unit, the second charging information received from the second communication unit as said another charging information, when determining to send said another charging information.

16. The method of claim 5, further comprising:
sending, by the first communication unit, said another charging information which contains flag information for indicating agreement on the second charging information of the second communication unit to the second communication unit, when determining to resend said another charging information.

17. The method of claim 1, wherein the first charging information comprises:
flag information for requesting the second communication unit to send the second charging information to the first communication unit; and
said obtaining the session request comprises:
obtaining another charging information from the first communication unit while sending the second charging information to the first communication unit according to the first charging information.

18. The method of claim 17, wherein said another charging information comprises flag information indicating agreement on the second charging information from the second communication unit.

19. The method of claim 2, further comprising:
when the first communication unit is a session initiator,
providing an actual charging information to the first communication unit to display to the user during the session or after the session.

20. A device for processing session, comprising:
a session message receiving/transmitting unit, configured to receive a session request for requesting a session between a calling user and a called user and send second charging information, wherein the session request includes first charging information;
a session processing unit, configured to process the session according to a result generated based on the first charging information received from the session message receiving/transmitting unit and the second charging information.

21. The device of claim 20, further comprising:
a charging rule storage unit, configured to store the second charging information;
an arithmetic comparing unit, configured to generate the result according to the first charging information received from the session message receiving/transmitting unit and the second charging information read from the charging rule storage unit, and send the result to the session processing unit.

22. The device of claim 21, wherein the session processing unit comprises:
a computing unit, configured to compute an actual fee or volume of the session;
a processing unit, configured to put through the session when the result received from the arithmetic comparing unit is that the first charging information accords with the second charging information, and terminate the session if the actual fee or volume of the session reaches a desired fee or volume in the first charging information; or acquire the second charging information from the charging rule storage unit when the result received from the arithmetic comparing unit is that the first charging information does not accord with the second charging information and notify the session message receiving/transmitting unit to send the second charging information to an initiator sending the first charging information.

23. The device of claim 22, wherein the session processing unit further comprises:
a request unit, configured to request an initiator sending the first charging information to resend another charging information when an actual fee or volume computed by the computing unit reaches a desired fee or volume in the first charging information after the session is put through.

24. The device of claim 20, further comprising:
a display unit, configured to display an actual fee and/or volume of the session acquired from the session processing unit.

25. The device of claim 20, wherein the device is a session initiator or a session server.

26. A device for processing session, comprising:
a first obtaining unit, configured to obtain a session request for requesting a session between a calling user and a called user, wherein the session request contains first charging information and is from a first communication unit;
a second obtaining unit, configured to obtain second charging information from a second communication unit;
a processing unit, configured to generate a result according to the first charging information and the second charging information and process the session according to the result.
